(19) United States
(12) Patent Application Publication
(10) Pub. No.: US 2004/0069722 A1
(43) Pub. Date: Apr. 15, 2004

(54) Filtering method

(76) Inventors: Bjarne Ekberg, Turku (FI); Olli Hognabba, Kantvik (FI)

Correspondence Address: Israel Blum, Morgan & Finnegan, 345 Park Avenue, New York, NY, 10154, US

(21) Appl. No.: 10/433,853

(22) PCT Filed: Dec. 7, 2001
(86) PCT No.: PCT/FI01/01062

(30) Foreign Application Priority Data
Dec. 8, 2000 (FI) 20002695

(51) Int. Cl. C02F 1/00

(52) U.S. Cl. 210/770

(57) ABSTRACT

The invention relates to a filtration method where the material to be filtered is brought into contact with the filtering surface of a filtering medium arranged in a suction drier, and on the filtering surface for the filtering medium, there is formed a filter cake, and the filter cake is subjected to a drying process constituting at least one step prior to removing the filter cake from the filtering surface of the filtering medium. According to the invention, in the filter cake drying process there is performed at least one drying step (12,22,32,42) during which gas is prevented from flowing through the filtering medium, and at least one drying step (13,23,33,44) during which gas flows through the filtering medium.

The present invention relates to a filtering method where the pressure difference between the ambient atmosphere and the liquid contained in the material to be filtered is adjusted during the various filtering steps.

The U.S. Pat. No. 4,357,758 specifies a capillary filtering method, where the material to be filtered when creating the filter cake is brought into contact with a microporous filtering medium saturated with a liquid. Consequently essentially all pores in the filtering medium are filled with liquid. The filter cake is formed on the surface of the filtering medium in a settling tank by utilizing the pressure difference between the ambient atmosphere and the liquid contained in the filtering medium. When forming the cake, the liquid is removed from the cake on the basis of said pressure difference. When all free liquid is removed from the filter cake pores, gas does not penetrate through the filtering medium, as is the case in conventional vacuum filtering. The reason for this is the capillary forces prevailing in the filtering medium.

A microporous filtering medium behaves like a large number of narrow capillary pipes that form a network. When the pressure difference ΔP is applied for a moist, hydrophilic pore with a radius r, the magnitude of the force that attempts to force the liquid out of the pore is ΔPπr². The force that attempts to keep the liquid in the pore is a vector force with a magnitude 2πrγcosα, where γ is surface tension and α is the wetting angle. The pressure difference ΔP is solved by marking the above mentioned forces to be equal in magnitude:

$$Δ P = \frac{2 γ cos α}{r}$$

ΔP describes the pressure difference that must be used if the capillary force prevailing in the porous material should be surpassed. When this pressure difference is surpassed, gas has access to flow through the pores. If the size of the pores is for instance 2 micrometers with a well wetting material, the pressure difference, when using pure water, is 1,4 bar. With pressure difference values lower than this limit pressure difference, gas does not flow through the pores. However, if water is brought onto the surface of the porous material, water passes through the capillaries formed by the pores with any pressure difference. The advantage of this kind of capillary filtering is that the use of pumping energy for the suction of gas through the filtering medium is avoided in the filtering process. Thus about 90% of the pumping energy is saved when compared to a conventional vacuum filtering. However, because gas cannot freely flow through the filtering medium, it is essential that gas cannot be used at all for improving the formation of the filter cake. The filter cake may become too compact on the filter cake surface, so that the residual moisture is difficult to remove from the filter cake.

The object of the present invention is to eliminate some of the drawbacks of the prior art and to achieve an advanced filtration method, where the various steps of the filtration process apply partly capillary filtration, partly conventional vacuum filtration. The essential novel features of the invention are apparent from the appended claims.

In a filtration method according to the invention, the material to be filtered in order to form the filter cake is brought into contact with the filtering medium, and the filtration takes place by applying both capillary filtration and vacuum filtration, so that the transfer from capillary filtration to vacuum filtration or vice versa is carried out between the various filtration steps. In the capillary filtration step, the pressure difference ΔP between the ambient atmosphere and the liquid contained in the filtering medium is maintained below the value defined by the filtering medium surface tension γ, wetting angle α and filtering medium pore radius r, said value being

$$Δ P = \frac{2 γ cos α}{r} \qquad ( 1 )$$

so that gas flow through the filtering medium is prevented. On the other hand, in vacuum filtration, the pressure P is maintained above the pressure difference value ΔP defined by formula (1), so that gas can flow through the filtering medium. By means of the gas flow, the particles and pores existing in the filter cake are mechanically rearranged, so that more liquid is removed from the filter cake.

When applying capillary filtration as such in the filtration process, the following steps can be distinguished: formation of the filter cake, drying of the filter cake, possible washing of the filter cake, removal of the filter cake and rewashing of the filtering medium. According to the invention, of the various steps of capillary filtration, for example the drying of the filter cake can advantageously be carried out by applying vacuum filtration. In that case the filtration method according to the invention includes at least one step that applies capillary filtration, during which step the flowing of gas through the filtering medium is prevented, and at least one step that applies vacuum filtration, during which step gas can flow through the filtering medium.

The gas flow through the filter cake and the filtering medium that is needed for the vacuum filtration steps in the filtration method according to the invention is advantageously created by means of a filter distribution element, i.e. a valve. The distribution element is divided into several sectors, and the pressure in each sector is controlled by means of control elements. The controlling of the pressure can also be carried out by pressure constriction in one or several sectors.

In the filtration method according to the invention, the permeability of gas through the moist filtering medium can, according to formula (1), also be controlled by adjusting the surface tension γ of the filtering medium. If gas penetration is allowed, it can be achieved by lowering the filtering medium surface tension by defining the bubble-point pressure to be lower than with pure liquid. Advantageously a change in the surface tension can be achieved for instance so that the washing of the filter cake is carried out by feeding surface active chemicals to the washing water of the filter cake.

If the filtration must be carried out with a predetermined pressure difference, the gas flow can be controlled advantageously by selecting a filtering medium that has a different wetting angle. For example, when using aluminium-based materials, the wetting angle α is 10 degrees, and cosα respectively 0,985. If the employed filtering medium is polyamide, the wetting angle α is 60 degrees and cosα respectively 0,500, in which case the pressure difference ΔP according to the invention the formula (1) drops to about half of the value of aluminium-based materials.

The filtration method according to the invention can be realized in a space that is essentially at least partly closed, in which space there can be created, when necessary, for instance an inert atmosphere by means of nitrogen or argon gas. In the essentially closed space, there can, when necessary, also be created reducing or oxidizing conditions. The at least partly closed space can also be used when, with proper attention to the process conditions, a particular chemical reaction should be achieved in the closed space between the filter cake and the gas atmosphere that surrounds the filter cake in the closed space.

The use of the filtration method according to the invention is described on more detail below, with reference to the appended drawings, where

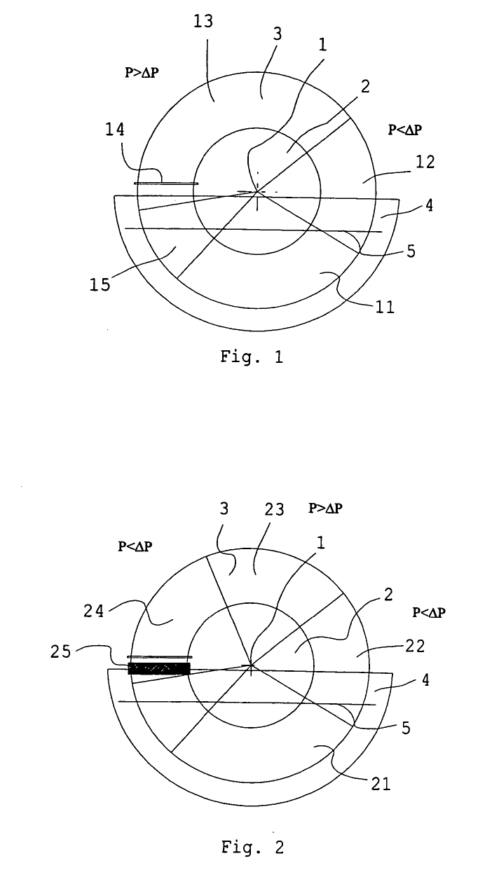

FIG. 1 illustrates a preferred embodiment of the invention, seen in a partial side-view cross-section,

FIG. 2 illustrates another preferred embodiment of the invention, seen in a partial side-view cross-section,

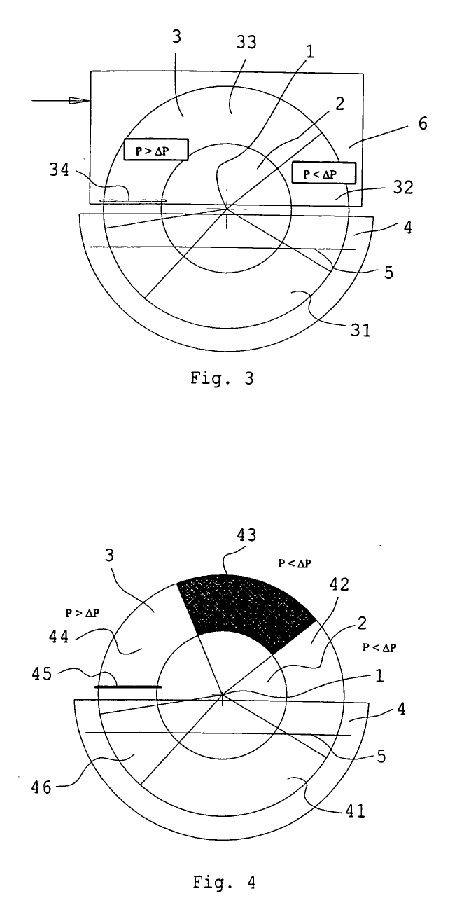

FIG. 3 illustrates a third preferred embodiment of the invention, seen in a partial side-view cross-section, and

FIG. 4 illustrates yet another preferred embodiment of the invention, seen in a partial side-view cross-section.

In FIG. 1, the filtration method according to the invention is applied in a suction drier, where in the housing 2 rotated around an axis 1, there is radially installed a filtration surface formed of one or several filtering elements 3 of the filtering medium. The housing 2 of the suction drier is arranged so that when rotating the housing 2 around its axis 1, the filtering surface of the suction drier is put to contact with the slurry 5 placed in the settling tank 4 that should be dried by filtering. In that case the filtering surface is, while the axis 1 rotates, part of the time underneath the slurry surface 5.

In FIG. 1, the filtering surface of the suction drier, formed of the filtering elements 2 of the filtering medium, is divided into sectors in order to illustrate the various filtration steps. The sectors are meant to schematically illustrate the various positions created around the filtering surface axis 1 during one rotary cycle with respect to the slurry 5 to be dried, and the sectors as such do not form an exact border between the different filtering steps.

In FIG. 1, at the step 11 in the method according to the invention, there is created a filter cake on the suction drier filtering surface by applying capillary filtration. The drying 12 of the filter cake is also begun with capillary filtration (P<ΔP), so that during this drying step, the majority of the free capillary liquid is removed from the filter cake. Thereafter the drying of the filter cake is continued as a vacuum filtration step 13, where the pressure difference ΔP according to formula (1) is surpassed (P>ΔP), and the gas flow is allowed to proceed through the filter cake and the filtering surface of the filtering medium. The gas flow rearranges the filter cake particles and pores mechanically, so that more liquid is removed from the filter cake. In addition, the gas flow as such takes along part of the liquid to be removed from the filter cake. The described drying step 13 may continue until the removal step 14, where the filter cake is removed mechanically from the filtering surface by means of scrapers. In FIG. 1, there also is marked the rewashing step 15.

In FIG. 2, there is used a similar suction drier as in FIG. 1, wherefore the reference numbers used in FIG. 2 are the same as in FIG. 1, as regards the suction drier. In FIG. 2, the filtering surface formed of the filtering elements 3 of the filtering medium is divided into sectors in similar fashion as in FIG. 1 in order to better illustrate the various filtering steps. The sectors are meant to schematically illustrate the positions of the filtering surface to with respect the slurry 5 to be dried when the axis 1 rotates around said surface during one rotation, and the sectors as such do not form an exact border between the different process steps.

According to FIG. 2, the filter cake is formed at step 21, and the formation of the filter cake is followed by a drying step 22 (P<ΔP) realized as capillary filtration, and a drying step 23 (P>ΔP) realized as vacuum filtration. As such, the drying steps 22 and 23 correspond to the drying steps 12 and 13 according to FIG. 1. However, the drying step 23 applying vacuum filtration is ended already before the removal step 25 of the filter cake, carried out by means of air blasting, so that the drying step 24 preceding the removal step 24 is realized as capillary filtration. In order to perform the removal step 25 by means of air blasting, there is needed an essentially even and controlled creation of a liquid film between the filter cake and the filtering medium, which is only possible if the drying step 24 preceding the removal step 25 is realized as capillary filtration. The reason for this is that if gas is allowed to enter the filtering medium at the preceding drying step 24, the liquid has not enough time to create an essentially even distribution on the filtering medium surface. In that case the filter cake sticks at those spots where the liquid has not had time to affect, and in other parts the filter cake is dissolved owing to an excessive liquid flow.

In the embodiment according to FIG. 3, there is further used a suction drier according to FIG. 1, with the difference that essentially for the whole part located above the settling tank 4, the suction drier is covered by a protective casing 6, inside which there is formed a non-oxidizing atmosphere—for instance by means of nitrogen or argon gas. In similar fashion as in FIGS. 1 and 2, the filtering surface composed of the filtering elements 3 of the filtering medium is divided into sectors in order to schematically illustrate the various steps of the filtration process.

In the embodiment according to FIG. 3, the material to be filtered is an organic material that must first be partly oxidized in order to improve the contact with air or with oxygen-enriched atmosphere prior to removing the filter cake from the suction drier. The organic material to be filtered is first formed into a filter cake at the step 31, whereafter follows the drying step 32 as capillary filtration. The created filter cake must not be subjected to an oxidizing atmosphere, and therefore the filter cake is transferred, during the drying step 32, from the slurry 5 to an inert nitrogen atmosphere created inside the protective casing 6. The drying step 32 is followed by a drying step 33 with vacuum filtration inside the protective casing 6, so that the inert nitrogen gas can freely flow through the filter cake and thus replace the oxygen earlier contained therein. After the drying step 33 applying vacuum filtration, the filter cake is removed mechanically at the removal step 34.

In an embodiment according to FIG. 4, there is used a suction drier according to FIG. 1 or 2. Also in FIG. 4, the filtering surface created by the filtering elements 3 of the filtering medium is divided into sectors in order to schematically illustrate the various steps of the filtration process. According to FIG. 4, the formation of the filter cake from the material to be filtered is carried out at step 41, when the filtering surface is essentially completely underneath the slurry surface 5. After the formation step 41 of the filter cake, there is carried out the filter cake drying step 42 by applying capillary filtration. The drying step 42 is followed by the filter cake washing step 43, where through the filter cake, there is conducted washing liquid while the pressure is lower than the pressure difference of formula (1), and thus within the capillary range (P<ΔP). After the washing step 43, there is realized a drying step 44 by applying vacuum filtration, so that the pressure is increased to above the pressure difference according to the formula (1). Finally the filter cake is removed from the filtering surface by a mechanical scraper 45, and the filtering surface is cleaned in a rewashing step 46 by feeding washing liquid through the filtering medium onto the filtering surface. After the rewashing step 46, a new cake formation step 41 begins.

1. A filtration method where the material to be filtered is brought into contact with a filtering surface of a filtering medium arranged in a suction drier, and onto the filtering surface of the filtering medium there is formed a filter cake, and the filter cake is subjected to a drying process with at least one process step prior to removing it from the filtering surface of the filtering medium, characterized in that in the filter cake drying process, there is carried out at least one drying step (12,22,32,42) during which the flowing of gas through the filtering medium is prevented, and at least one drying step (13,23,33,44) during which gas flows through the filtering medium.

2. A filtration method according to claim 1, characterized in that the pressure difference between the ambient atmosphere and the liquid contained in the material to be filtered is adjusted during the various filtration steps.

3. A filtration method according to claim 1 or 2, characterized in that the drying of the filter cake is started with a drying step (12,22,32,42) during which gas is prevented from flowing through the filtering medium.

4. A filtration method according to claim 1, 2 or 3, characterized in that the filter cake drying step (13,23,33,44) during which gas flows through the filtering medium, is carried out between two drying steps, during which gas is prevented from flowing through the filtering medium.

5. A filtration method according to claim 1, 2 or 3, characterized in that between the filter cake drying step (12,22,32,42) during which gas is prevented from flowing through the filtering medium, an the filter cake drying step (13,23,33,44) during which gas flows through the filtering medium, there is carried out the filter cake washing step (43).

6. A filtration method according to any of the preceding claims, characterized in that the filter cake drying steps are carried out in a closed atmosphere (6).

7. A filtration method according to claim 6, characterized in that the filter cake drying steps are carried out in an inert atmosphere.

8. A filtration method according to claim 6, characterized in that the filter cake drying steps are carried out in reducing conditions.

9. A filtration method according to claim 6, characterized in that the filter cake drying steps are carried out in oxidizing conditions.
